(19) United States
(12) Patent Application Publication
(10) Pub. No.: US 2010/0052318 A1
(43) Pub. Date: Mar. 4, 2010

(54) System and Method of Joining Fluid Transporting Tube and Header Using Internal Ferrule

(75) Inventor: Andrew S. Manninen, Grand Haven, MI (US)

Correspondence Address: REINHART BOERNER VAN DEUREN P.C., 2215 PERRYGREEN WAY, ROCKFORD, IL, 61107, US

(73) Assignee: Woodward Governor Company, Fort Collins, CO (US)

(21) Appl. No.: 12/199,349

(22) Filed: Aug. 27, 2008

(51) Int. Cl. F16L 21/02

(52) U.S. Cl. 285/339

(57) ABSTRACT

A system and method for joining a tube to a header is provided. The system includes a header, tube and internal ferrule, wherein the ferrule is fixed inside the tube. This design reduces manufacturing cost and time, as well as reducing and more evenly distributing stress along the tube-header assembly.

### FIELD OF THE INVENTION

This invention generally relates to a system and method of joining a tube to a header, more particularly, an assembly of a fluid transporting tube and a header joined using a ferrule.

### BACKGROUND OF THE INVENTION

Much development has been made in the area of joints formed between ends of fluid transporting tubes and a header plate receiving those tubes. For example, various methods of joining fluid tubes, such as coolant tubes, to a header has been developed to extend duration and durability of heat exchangers.

One of the well known methods of joining a tube to a header involves a ferrule. Often, a ferrule is designed to gradually transfer stress from the tube to the ferrule, thereby increasing allowable loading and life span of the joint. Without the ferrule, a header-tube joint is subjected to a maximum stress of the system, and thus, often becomes a point of failure. In some applications, the ferrule is integrally formed with the header, wherein the tube is received and seated. Such a joining method using an integral ferrule-header is commonly practiced in manufacturing of afterburner spray bars for some jet engines.

There are several limitations with the integral ferrule-header designs. First, the integral ferrule-header systems can be relatively costly to manufacture. This is because manufacturing of the integral ferrule-header can involve complex engineering and equipment, which can be a lengthy and expensive process. Second, a design of the integral ferrule-header is limited by current manufacturing capabilities, which often does not allow for production of a desired geometry of a ferrule-header. Further, in such a ferrule-header system a stress concentration can be induced in the tube proximate a ferrule.

In view of these limitations, there is a need in the art for improved system and method of joining fluid transporting tubes with a header. The present invention pertains to such improvements to the state of the art of a tube-header assembly using an internal ferrule.

### BRIEF SUMMARY OF THE INVENTION

In view of the above, embodiments of the present invention provide a new and improved system and method of joining tubes to a header that overcomes one or more of the limitations existing in the art. More particularly, embodiments of the present invention provide a new and improved tube-header assembly incorporating an internal ferrule. Such embodiments significantly improve the performance of the tube-header assembly by more evenly distributing external stress. Such embodiments are relatively simple to engineer and easy to manufacture, and thus reduce overall cost of the tube-header assembly.

In one aspect, the invention provides a tube-header joint for a fluid transport system including a tube, an internal ferrule and a header, wherein the internal ferrule is attached within the tube. Further, the header includes an aperture, wherein the tube is fixed.

In another aspect, the invention provides a method of assembling a tube-header joint for a fluid transport system including forming a tube, forming a flared end in at least one end of the tube, making an internal ferrule, fitting the internal ferrule in the flared end of the tube, forming a header including an aperture, and attaching the flared end of the tube in the aperture

In yet another aspect, the invention provides a method of reducing an external stress concentration on a tube-header joint for a fluid transport system including forming a tube-header joint comprising a tube, a header and a ferrule, wherein the ferrule is positioned inside of the tube. The method of reducing an external stress concentration on a tube-header joint also excludes an external ferrule from the tube-header joint.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross sectional view of a tube-header joint comprising a tube, a header and an internal ferrule, according to an embodiment of the present invention;

FIG. 2 is a cross sectional view of the internal ferrule of FIG. 1;

FIG. 3 is a cross sectional view of a conventional tube-header joint; and

FIG. 4 is a schematic illustration of stress distribution on the tube-header joint of FIG. 1 compared to the conventional tube-header joint of FIG. 3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

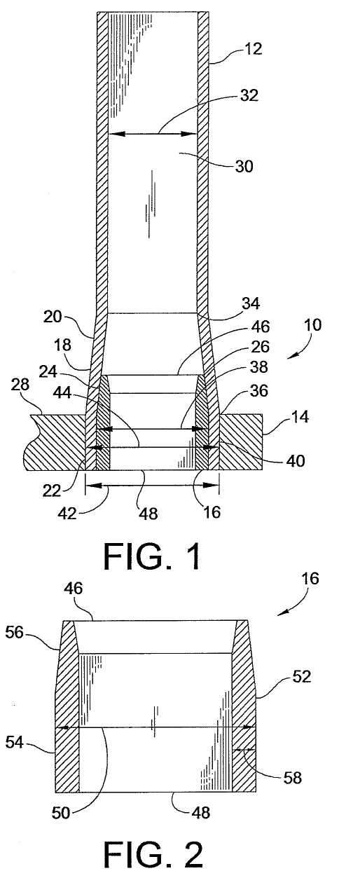

FIG. 1 shows a cross sectional view of a tube-header joint 10 according to an embodiment of the present invention. The tube-header joint 10 comprises a tube 12, a header 14, and an internal ferrule 16. The tube 12 is generally a cylindrical in its shape and swaged at one end, wherein a flared end 18 is formed. The header 14 includes an aperture 22, which extends from an upper surface 28 of the header 14, and down through the thickness of the header 14. The header 14 and the tube 12 are configured such that the flared end 18 of the tube 12 fits tightly into the aperture 22 of the header 14. The internal ferrule 16 is a separate piece, configured to fit into the flared end 18 of the tube 12.

The tube 12 of this embodiment is adapted to transport fluid, for example, fuel in an afterburner system in some jet engines, through a flow path 30 defined within the tube 12. The cylindrical tube 12 has a circular cross section having an inner diameter 32, which gradually increases from point 34 to point 36, thereby forming the flared end 18. The flared end 18 has a sloped portion 20, defined by a portion of the tube 12 between the point 34 and the point 36, and a tube insert 40 having a constant inner diameter 38.

The aperture 22 of the header 14 has a circular cross section to fit the tube insert 40. Thus, an inner diameter 42 of the aperture 22 is almost equal to an outer diameter 44 of the tube insert 40 with just enough clearance to tightly fit them together. In other embodiments, the tube insert 40 may be sloped, either flaring or constricting, as such the aperture 22 of such embodiments is configured accordingly to fit such shapes.

FIG. 2 shows the internal ferrule 16 of FIG. 1 before it is fitted into the flared end 18 of the tube 12. The internal ferrule 16 is generally cylindrical in its shape and includes an inlet end 46 and an outlet end 48. The shape of an outer surface 52 of the internal ferrule 16 mirrors the inner surface of the flared end 18. That is, the internal ferrule 16 comprises a body 54 corresponding to the tube insert 40 and a tip 56 corresponding to a part of the sloped portion 20 of the flared end 18. As shown, the internal ferrule 16 is shorter in length than the flared end 18 of the tube 12, as such the tip 56 of the internal ferrule 16 does not extend into the entire sloped portion 20 of the flared end 18. However, in other embodiments, the internal ferrule 16 and the flared end 18 of the tube 12 may be designed to have a same length, such that the internal ferrule 16 extends through the entire flared end 18 to the point 34.

Now that each component of the tube-header joint 10 is described, a method of assembling the tube-header joint 10 according to the present invention will be explained.

In one embodiment, the tube 12 is swaged at one end in a swaging machine using swaging dies designed to form the flared end 18. For example, the tube 12 can be fed into a swaging die opening, wherein the swaging die rotates to widen an end of the tube 12 into a desired shape by centrifugal force. Once the tube 12 is swaged to form the flared end 18 the internal ferrule 16 is inserted, with the tip 56 first, into the flared end 18 through the tube insert 40. In other embodiments, the tube 12 may be preformed to include a flared end 18.

In the tube 12, the internal ferrule 16 is joined with the flared end 18 of the tube 12 by a suitable manufacturing process such as brazing, welding, press-fit, shrink-fit, hold-down spring, etc. For example, in a brazing process, an inner surface 24 of the flared end 18 and/or an outer surface 52 of the internal ferrule 16 maybe applied with a filler material, such as silver, tin, zinc, copper, etc., and heated to the melting temperature of the filler material such that the filler material melts and metallurgically bonds the tube 12 and the internal ferrule 16 together. In such an embodiment, the tube 12 and the internal ferrule 16 are formed of a metallic material having a higher melting temperature than the brazing filler material. The tube 12 and the internal ferrule 16 may be formed of a same or different metallic materials. The tube 12 joined with the internal ferrule 16 is fitted into the aperture 22 of the header 14, wherein the tube insert 40 is joined with the header 14 by a suitable manufacturing process similar to the process used for joining the internal ferrule 16 and the flared end 18 of the tube 12.

In a different embodiment, the tube 12 may be first joined with the header 14 by attaching an outer surface of tube insert 40 with an inner surface of the header aperture 22 by a suitable manufacturing process. The internal ferrule 16 may then be inserted into the flared end 18 of the tube 12 such that the outlet end 48 of the internal ferrule 16 is flushed with an end of the tube insert 40. The internal ferrule 16 may be attached with the flared end 18 via suitable process. For example, the internal ferrule 16 can be press-fit into the flared end 18.

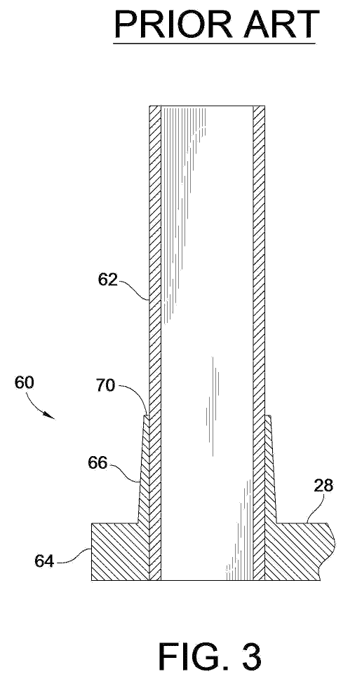

The internal ferrule 16 is advantageous over a conventional system, wherein a ferrule is integrally formed with a header plate. An example of the conventional tube-header joint is illustrated in FIG. 3. As shown, a conventional tube-header joint 60 comprises a tube 62, a header 64 and a ferrule 66, wherein the ferrule 66 is integrally formed with the header 64. Further, the ferrule 66 is external to the tube 62. Production of such integrated ferrule 66-header 64 piece can often involve complex engineering and manufacturing processes. On the other hand, the internal ferrule 16 of the present invention is relatively simple to design and manufacture since it is a separate piece from the header, and thus, can reduce manufacturing costs compared to the conventional integrated ferrule-header piece.

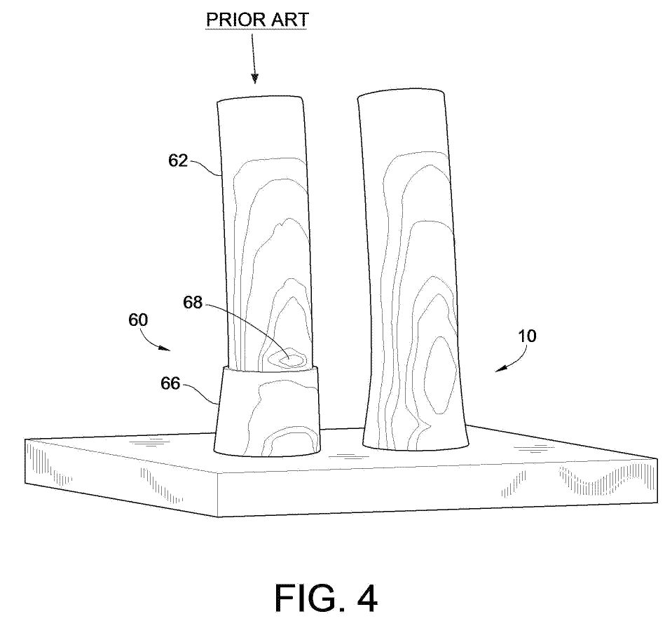

Further, the placement of a ferrule inside of a tube also improves stress distribution on a tube-header joint. FIG. 4 is a schematic illustration of stress distribution around the tube-header joints 60, 10. As shown, the conventional tube-header joint 60 of FIG. 3 comprising the external ferrule 66 can drive the stress that it is under to a focused region 68 on the tube 62, immediately above the external ferrule 66. On the other hand, the tube-header joint 10 comprising the internal ferrule 16 allows for the loading to be spread more uniformly throughout the tube-header joint 10, thereby decreasing a maximum stress at any one particular point. This is because the placement of the ferrule inside of the tube eliminates a built-in stress concentration in the conventional tube-header joint 60 due to a step from a header 64 to tube 62 from a difference in their outer diameters. By distributing an external stress applied to the tube-header joint 10 more uniformly over a larger area, it reduces the maximum stress at a focused area, and thus, increases the amount of stress that the tube-header joint 10 can endure before failure. Therefore, the tube-header joint 10 of the present invention can have increased product life span with respect to high cycle fatigue.

Test results confirmed reduced von Mises stress at an intersection of the ferrule and tube for the tube-header joint 10 of the present invention when compared with the conventional tube-header joint 60. The test results showed that the tube-header joint 10 had von Mises (Max) stress of 164.3 Ksi at a tube-ferrule intersection 26. (FIG. 1). The conventional tube-header joint 60 had a von Mises (Max) stress of 178.9 Ksi at an tube-ferrule intersection 70. (FIG. 3). In other words, the tube-header joint 10 comprising the internal ferrule 16 of the present invention had about 9% lower von Mises maximum stress than the conventional tube-header joint 60 using the external ferrule 66.

A tube-header joint comprising an internal ferrule according to the present invention provides many benefits. The internal ferrule substantially decreases manufacturing costs, because it is a separate piece from a header, and has a relatively simple structure. As such, the internal ferrule allows for a decrease in complexity of engineering and manufacturing the header and the ferrule, resulting in savings in manufacturing costs. Further, the internal ferrule improves overall performance of the tube-header joint, by eliminating a stress concentration point.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tube-header assembly for a fluid transport system comprising:
a tube, the tube having an inner surface;
an internal ferrule, the internal ferrule attached to the inner surface of the tube;
a header having an aperture, wherein the tube is fixed in the aperture.

2. The tube-header assembly of claim 1, wherein the tube includes a tube body and a swaged end, the swaged end having a larger diameter than the tube body; wherein the internal ferrule is closely fitted in the swaged end.

3. The tube-header assembly of claim 2, wherein the swaged end is attached within the aperture.

4. The tube-header assembly of claim 2, wherein the swaged end has a sloped portion and a tube insert portion; wherein a diameter of the tube body increases in the sloped portion and remains at a constant diameter in the tube insert portion; the diameter of the tube body being smaller than the diameter of the tube insert portion.

5. The tube header assembly of claim 4, wherein the internal ferrule extends through the tube insert portion and at least some of the sloped portion; the internal ferrule having an outer surface, wherein the outer surface of the internal ferrule has a contour mirroring a contour of an inner surface of the corresponding sloped portion and the tube insert portion, such that the internal ferrule fits closely in the swaged end.

6. The tube header assembly of claim 5, wherein the internal ferrule is permanently attached to the swaged end of the tube.

7. The tube-header assembly of claim 1, wherein the tube-header joint is configured without an external ferrule, thereby eliminating a stress concentration point on an outer surface of the tube.

8. A method of joining a tube and a header for a fluid transport system comprising:
forming a flared end in at least one end of the tube;
making an internal ferrule;
fitting the internal ferrule in the flared end of the tube;
forming a header including an aperture; and
attaching the flared end of the tube in the aperture.

9. The method of claim 8, wherein forming a flared end comprises swaging at least one end of the tube to increase a diameter of the tube in the flared end.

10. The method of claim 8, wherein making an internal ferrule comprises contouring an outer surface of the internal ferrule to mirror at least a portion of the flared end of the tube.

11. The method of claim 10, wherein fitting the internal ferrule comprises inserting the internal ferrule into the flared end such that an end of the internal ferrule and an end of the flared end are even, wherein the internal ferrule is permanently attached to the flared end.

12. The method of claim 11, wherein the internal ferrule is permanently attached to the flared end by one of brazing, welding, press-fitting, or shrink-fitting.

13. The method of claim 11, wherein attaching the flared end of the tube in the aperture is performed after fitting the internal ferrule in the flared end; wherein the attaching the flared end in the aperture comprises inserting the flared end into the aperture and permanently bonding them together.

14. The method of claim 11, wherein the attaching of the flared end of the tube in the aperture is performed before fitting the internal ferrule in the flared end, wherein the tube is joined with the header by inserting the flared end into the aperture, then inserting the internal ferrule into the tube through the flared end, such that the header, tube and the internal ferrule are permanently joined to form the tube-header joint.

15. A method of reducing an external stress concentration on a tube-header assembly for a fluid transport system comprising:
forming a tube including a flared end in at least one end of the tube;
forming a header including an aperture, wherein the aperture is sized to fit the flared end of the tube;
forming a ferrule, the ferrule configured to fit within the flared end of the tube;
assembling the tube, the header and the ferrule, wherein the ferrule is attached within the flared end of the tube.

16. The method of claim 15, wherein the forming of a tube comprises swaging the at least one end of the tube to form the flared end, wherein the flared end has an increased diameter.

17. The method of claim 15, wherein the assembling comprises inserting the ferrule into the flared end such that an end of the ferrule and an end of the flared end are even, wherein the ferrule is permanently attached to an inner surface of the flared end of the tube, wherein an assembly of the tube and the ferrule is inserted into the aperture of the header, wherein an inner surface of the aperture and an outer surface of the flared end is permanently attached.

18. The method of claim 17, wherein the ferrule, the flared end of the tube, and the aperture of the header are attached by one of brazing, welding, press-fitting or shrink-fitting.

19. The method of claim 15, wherein the assembling comprises inserting the flared end of the tube into the aperture of the header, then inserting the ferrule into the flared end of the tube, wherein the ferrule is attached to an inner surface of the flared end and an outer surface of the flared end is attached to an inner surface of the aperture.

20. The method of claim 19, wherein the ferrule, the flared end of the tube, and the aperture of the header are attached by one of brazing, welding, press-fitting or shrink-fitting.
